(19) United States
(12) Patent Application Publication
(10) Pub. No.: US 2018/0334253 A1
(43) Pub. Date: Nov. 22, 2018

(54) AIRCRAFT COMPRISING A WING FORMED BY A PLURALITY OF DISTRIBUTED AIRFOILS

(71) Applicant: Airbus SAS, Blagnac (FR)

(72) Inventor: Jean-Francois GENESTE, Toulouse (FR)

(73) Assignee: Airbus SAS, Blagnac (FR)

(21) Appl. No.: 15/773,474

(22) PCT Filed: Nov. 9, 2016
(86) PCT No.: PCT/FR2016/052899

§ 371 Date: May 3, 2018

(30) Foreign Application Priority Data
Nov. 12, 2015 (FR) 1560833

(51) Int. Cl. B64C 39/08; B64C 3/38; B64C 3/40

(52) U.S. Cl. CPC B64C 39/08; B64C 3/40; B64C 3/385

(57) ABSTRACT

An aircraft including a fuselage and at least one wing comprising, on the aerodynamic plane, a plurality of distributed airfoils separated from one another, numbering more than 10, and arranged inside an enclosing space bearing on the airfoils. The shape and dimensions of the enclosing space correspond to the shape and dimensions of a simple wing of conventional structure, which is adapted to the aircraft taking account of the weight and flight speed of the aircraft. Advantageously, the airfoils are arranged such that the cross-section of the enclosing space in a vertical plane XZ of the aircraft matches the shape of the aerodynamic profile of the simple wing of conventional structure. The airfoils are arranged, for example, to produce a V formation in plan view, with the tip pointing forwards.

### CROSS-REFERENCES TO RELATED APPLICATIONS

This application claims the benefit of the French patent application No. 1560833 filed on Nov. 12, 2015, the entire disclosures of which are incorporated herein by way of reference.

### FIELD OF THE INVENTION

The invention belongs to the field of aircraft and aircraft wings.

The invention concerns more particularly an aerodynamic architecture of an aircraft in which a multitude of elementary airfoils are distributed in space and arranged relative to each other to produce the lift necessary for flight of the aircraft, and so as to interact to limit the unfavorable effects on drag and on the global mass of the airfoils.

The plurality of airfoils is arranged in particular so as to constitute organized formations of airfoils, such as 2-D arrangements which can be observed in the flights of migrating birds, wild geese for example, or 3-D arrangements which can be observed in shoals of fish living in groups.

### BACKGROUND OF THE INVENTION

In the field of aircraft, the lift force which opposes weight and allows the aircraft to fly is provided, in the very great majority of cases, by a wing fixed to the fuselage such that the wing surface is distributed symmetrically on the left and right sides of the fuselage.

Most often, the wing is formed by a single airfoil, more rarely by two or three superposed airfoils, exceptionally more, with similar dimensions in span and surface area, or offset longitudinally.

In all known cases, the surfaces forming the wings each correspond geometrically to an airfoil of a wing or a tailplane designed as such, multiplication of which has the sole purpose of obtaining the total lift necessary while mitigating structural limitations.

In the case of multi-wing aircraft with superposed airfoils, use of which was common in the beginnings of aviation, as illustrated by the drawing in FIG. 1 of the Caproni CA60, the aerodynamic performance of the wing, in particular the drag, is degraded, but in the aim of increasing the useful payload, the total airfoil surface area was increased despite the structural limits of the era.

The wing develops an aerodynamic lift force because of its displacement relative to the air mass in which the aircraft is moving.

The lift force L is, in particular, proportional to the surface area Sw of the wing and to the square of the speed V0 relative to the flow in relation to the aircraft. It is also a function of a coefficient of lift CL, itself characteristic of the aerodynamic profile of the wing and its angle of attack, and the density p of the air which in the atmosphere is a function of altitude and temperature.

This lift force L is translated into the following equation:

L=½ρ Sw CL V02

The wing of an aircraft also generates a drag D, one component of which, the friction drag Df, is linked to the friction of the aerodynamic flow on the surfaces of the airfoils, and another component of which, the induced drag Di, originates in the lift. The wing also generates other drag forces such as form drag and wave drag, for the latter when the speed no longer allows the effects of compression to be ignored because of the Mach number of flight.

The drag D of the wing corresponds in practice to the sum of the various forms of drag, the relative sizes of which are a function of the characteristics of the wing, and for a given aircraft are a function of the flight conditions of the aircraft.

For more than a century, in the development of aircraft, wings have been adapted to the needs of increasing mass on take-off and higher-flying speeds of aircraft by the development of the surfaces and increases in wing loading.

However, these developments took place on a geometric level without questioning the conventional wing design, which has only developed substantially in its secondary characteristics, i.e., mainly its geometric extension, its sweep, its shape in plan and its taper, its relative thickness, and its fixing to the structure of the fuselage.

With the progress made, in particular in the field of structures, the solution of multi-plane wings has been abandoned in favor of single wings except in rare cases of small biplane aircraft.

FIG. 2 illustrates an example of a civil passenger transport aircraft 90 comprising such a conventional wing 91 fixed to a fuselage 92, and a rear tailplane assembly 93.

### SUMMARY OF THE INVENTION

The present invention provides a new airfoil architecture to improve the aerodynamic qualities of an aircraft, in particular in relation to the aerodynamic drag.

The aircraft of the invention comprises a fuselage and at least one wing. On an aerodynamic level, the wing comprises a plurality of airfoils, numbering ten or more, arranged inside an enclosing volume bearing on the airfoils, of shapes and dimensions of a wing of conventional structure which is adapted to the aircraft taking account of a mass and a flying speed of the aircraft.

The arrangement of multiple airfoils distributed in a volume, similar to the volume defined by a conventional wing adapted to the flying conditions of the aircraft concerned, allows the aerodynamic forces to be distributed over the different airfoils while utilizing the aerodynamic interactions between the different airfoils, which are necessarily close together in the volume concerned.

In one embodiment, the cross-sections of the enclosing volume, in vertical planes XZ in a reference system of the aircraft, have the shape of an aerodynamic profile.

Thus, in a limited volume, a total surface area of the airfoils is obtained which may be greater than the surface area in plan of the enclosing volume.

In one embodiment, the enclosing volume has a shape in plan, viewed from above, belonging to one of the shapes: rectangular, trapezoid, multi-trapezoid, elliptical. Also in one embodiment, which may be combined with the various shapes in plan, the enclosing volume has a shape in plan, viewed from above, presenting a sweep. The sweep angle may be positive towards the rear or negative towards the front.

Thus, a wing is formed with airfoils which can assume an overall shape in plan corresponding to a shape adapted to the flying conditions of the aircraft concerned.

In one embodiment, a height of the enclosing volume considered in the vertical direction Z of an aircraft reference axis system is always greater, at any point of the enclosing volume, than a sum of the heights of the airfoils for each of the points considered, other than points of a leading edge or a trailing edge of the enclosing volume.

Thus, a transparency of the wing to the aerodynamic flow in the longitudinal direction is achieved, such that all airfoils in the enclosing volume of the wing are exposed to the aerodynamic flow.

In one embodiment, all or some of the airfoils are fixed to the fuselage via a root of each of the airfoils concerned. In this case, each airfoil concerned is fixed directly to the fuselage, and arrangements of structures used on conventional aircraft for fixing wings or tailplanes may be used.

In one embodiment, the wing comprises several separate airfoils distributed along a span of the enclosing volume. It is thus possible, while using simple elementary shapes for the airfoils, to distribute the airfoils in an enclosing volume of complex shape and/or to respect a relative arrangement of the airfoils to each other.

In particular in one embodiment, the airfoils are arranged in the enclosing volume following a span of the wing, such that they give at least one V-shape when viewed from above, the tip of which is oriented towards a leading edge of the wing.

In one embodiment, all or some of the airfoils are assembled to pivot individually or in groups about an axis oriented following a direction of a transverse axis Y of an aircraft reference axis system, or oriented following a direction substantially parallel to a direction of a span of the wing, or oriented following a span of the airfoil concerned, so as to allow modification in flight of a pitch angle aα of the airfoil concerned relative to a longitudinal axis X of the aircraft reference axis system.

It is thus possible to modify in flight the angle of attack of an airfoil, in particular by modification of its pitch angle, and globally to modify the distribution of the lift and aerodynamic drag in the wing, in particular to ensure control of the aircraft in pitch, roll or yaw of the aircraft.

In one embodiment, some or all of the airfoils are assembled to pivot individually or in groups about an axis oriented following a direction substantially parallel to a vertical axis Z of an aircraft reference axis system, so as to allow modification in flight of a sweep angle of the airfoil concerned relative to a lateral direction Y of the aircraft reference axis system.

It is thus possible to adapt the wing to given flight conditions, in particular, speed.

In one embodiment, the fuselage comprises several streamlined forms held together by the airfoils of the wing.

Thus, an aircraft is produced with a fuselage comprising several separate independent compartments held together by a plurality of airfoils, which ensure not only an aerodynamic lift distributed between the different airfoils, but also a distributed structural connection.

### BRIEF DESCRIPTION OF THE DRAWINGS

The description and drawings of an exemplary embodiment and implementation of the invention serve to better present the aims and advantages of the invention. It is clear that this description is given as an example and have no limitative character.

In the drawings:

FIG. 1 cited above shows a photograph of a passenger transport aircraft with a multi-plane wing from the beginnings of transport aviation;

FIG. 2 cited above is an isometric diagram of a modern transport aircraft with a monoplane wing;

FIG. 3 is an example of a wing with trapezoid airfoils distributed in the enclosing volume of the wing;

FIG. 4 is a cross-sectional view of the wing of the invention showing the outer surface of the enclosing volume and the cross-sections of the airfoils distributed in the enclosing volume;

FIG. 5 is a section AA in a vertical plane YZ of the wing shown on FIG. 4, in cross-section in a plane XZ;

FIG. 6 is an example arrangement with a wing of elliptical shape in plan view, in the enclosing volume of which elliptical airfoils are arranged distributed in the span and forming a V-shaped arrangement;

FIG. 7 is a plan view of the wing and airfoils of FIG. 4 spanning between two streamlined bodies.

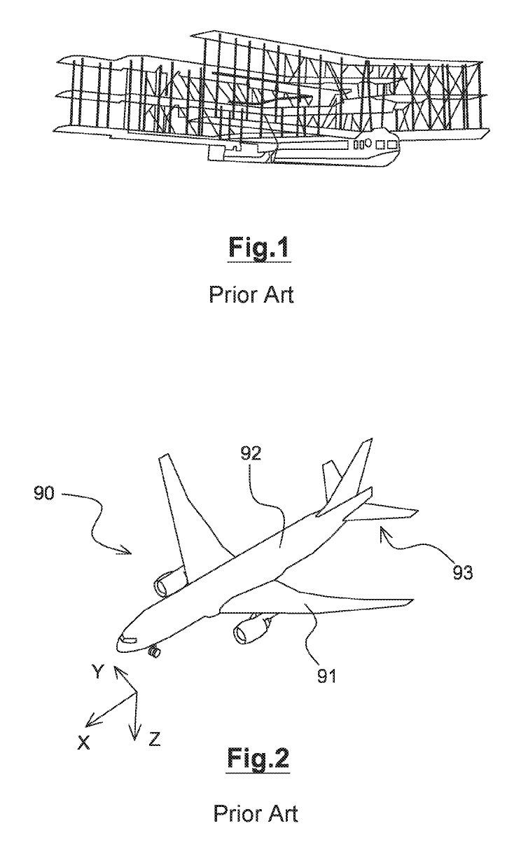

The drawings show diagrammatic representations of the guiding principles of the invention, and on a given figure or in different figures, parts representing elements with the same function even with different forms are identified with the same reference.

The drawings are not shown to scale, and different elements are not necessarily drawn to the same scale on the same drawing or on different drawings.

In the description, as far as necessary, an axis system linked to the aircraft is used. The axis system linked to the aircraft conventionally comprises a longitudinal axis X oriented positively substantially in a direction from the rear towards the front of the aircraft, a vertical axis Z perpendicular to axis X and oriented positively downward, and a lateral axis Y perpendicular to the plane XZ and oriented positively to the right of the aircraft, so as to form a direct orthogonal trihedral XYZ.

### DETAILED DESCRIPTION OF THE PREFERRED EMBODIMENTS

An aircraft 100 according to the invention comprises a fuselage 50 and a wing 10, the principles of which are described below in one embodiment.

The aircraft 100 comprises as necessary balancing and control surfaces, such as a horizontal tailplane to balance the aircraft in pitch during flight and a vertical tailplane to balance the aircraft in yaw. These balancing and control surfaces are not shown on the drawings or described in the detailed description. They do not form the subject of the invention, and the person skilled in the art will implement the known methods and techniques of aircraft design, taking into account the aerodynamic characteristics of the assembly of the wing 10 and the fuselage 50. However, these balancing and control surfaces are surfaces generating aerodynamic forces and may be produced following the principles of the wing of the invention.

The aircraft also comprises propulsion engines as necessary. The drawings of the invention do not show the propulsion system, and the person skilled in the art will use his knowledge in the field of aircraft propulsion to fix the propulsion engines on the aircraft structure. In the case of the invention, because of the structure of the wing, preferably the engines are fixed to the fuselage.

It is known in the field of fluid dynamics that the presence of a body in a flow disrupts the flow, and that the flow generates on the body pressures on the surface of the body.

The integral of pressures gives torsion values which may be reflected by a force and a torque applied at a selected point of the body.

In the known fashion, by projection into an axis system linked to flow, the force breaks down into a lift L and an aerodynamic drag D.

When several bodies are placed in a flow at sufficiently close distances of the same order of magnitude as the dimensions characteristic of the bodies, the flow disruptions caused by each of the bodies will affect the flow characteristics on the other bodies, and as a result, in relation to the flow, a collective behavior of the group of bodies occurs which is not the simple addition of the individual effects on the bodies if these were placed isolated from each other in a same flow and infinitely upstream.

An illustration of this type of collective behavior is observed in the precipitation of solid particles within a fluid which, all other things being equal, is sensitive to the density of particles in number per unit of volume and to the presence or absence of a wall confining the flow, being on the scale of the group of particles in precipitation.

In the present invention, from aerodynamic aspects, a group behavior has been exploited by replacing a conventional wing, such as the wing 91 of the aircraft 90 illustrated on FIG. 2, by a wing formed mainly from a plurality of airfoils of smaller dimensions, forming a group and distributed to ensure at least the functions performed by a conventional wing.

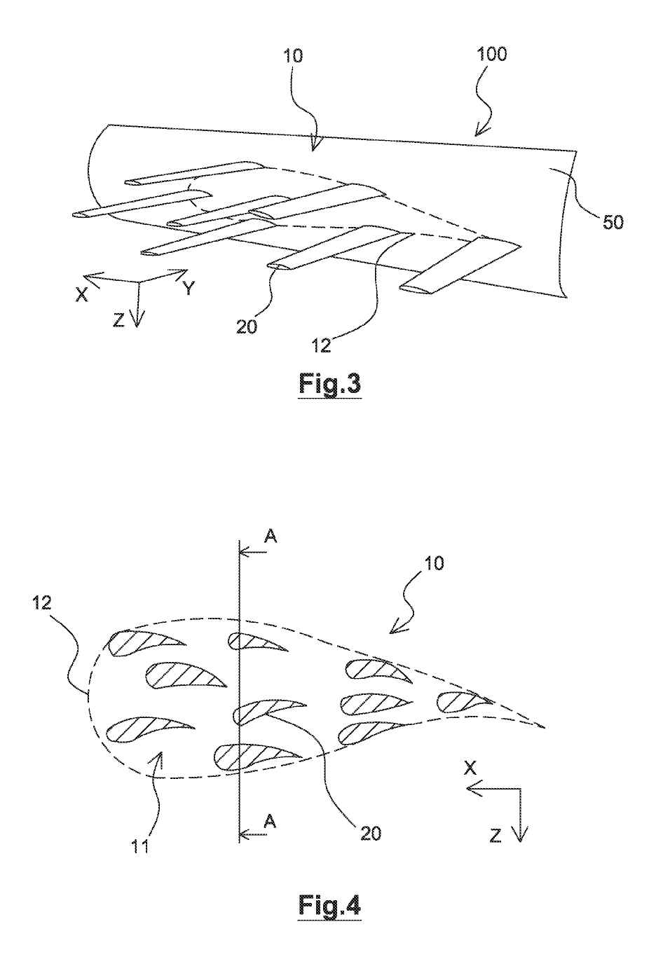

FIG. 3 illustrates a first example of an embodiment of an aircraft 100 according to the invention, in which the wing 10 comprises a plurality of airfoils 20 distributed in a volume of the space determining the volume of a virtual wing.

The airfoils 20 are held in their relative positions by a connection structure to which each of the airfoils is fixed.

On the example of FIG. 3, an aircraft fuselage 50 performs the function of the connecting structure, each airfoil being of elongate form in span and fixed by a root of the airfoil to the fuselage in the manner of a conventional wing, i.e., so as to transmit the forces between the airfoil and the fuselage.

FIG. 3 shows the aircraft 100 from one side only of a portion of the fuselage 50, partially depicted, wherein airfoils not visible on the figure are also distributed, preferably substantially symmetrically, on an opposite side of the fuselage, at least so as to fulfill the conditions of lateral aerodynamic balance of the aircraft, in the same way as a conventional aircraft wing has an overall symmetry relative to an axial, longitudinal, vertical plane of the fuselage, as in the example illustrated in FIG. 2.

In this exemplary embodiment, the fuselage is a streamlined body, a main axis of which is oriented in flight substantially in the direction of aerodynamic flow, as implemented in the known fashion to transport a payload of an aircraft.

The term “plurality of airfoils” means that the number of airfoils 20 is sufficient to give the plurality of the airfoils a collective behavior on an aerodynamic level which is substantially different from that of a conventional wing with a surface area Sw equivalent to a sum of the individual surface areas Ssp(i) of the airfoils. In practice, a number of ten or more airfoils 20, preferably at least fifteen airfoils, is used in the wing 10 on each side of the fuselage, wherein the drawings do not necessarily show such a number for reasons of clarity of the illustration. The number of ten airfoils is necessary to obtain the desired benefit of the aerodynamic interactions.

FIG. 4 illustrates, through a cross-section of the wing 10, an example of the relative positions of the airfoils 20 on one of the sides of the fuselage 50.

The relative positions determine an enclosing volume 11 bearing on the airfoils 20 and corresponding to the wing 10 in which the individual volumes of the airfoils are contained, the enclosing volume corresponding in cross-section along a vertical plane XZ substantially to an aerodynamic profile as indicated by an outline of a surface 12 of the enclosing volume, drawn on FIG. 4 and also marked on the fuselage 50 of FIG. 3.

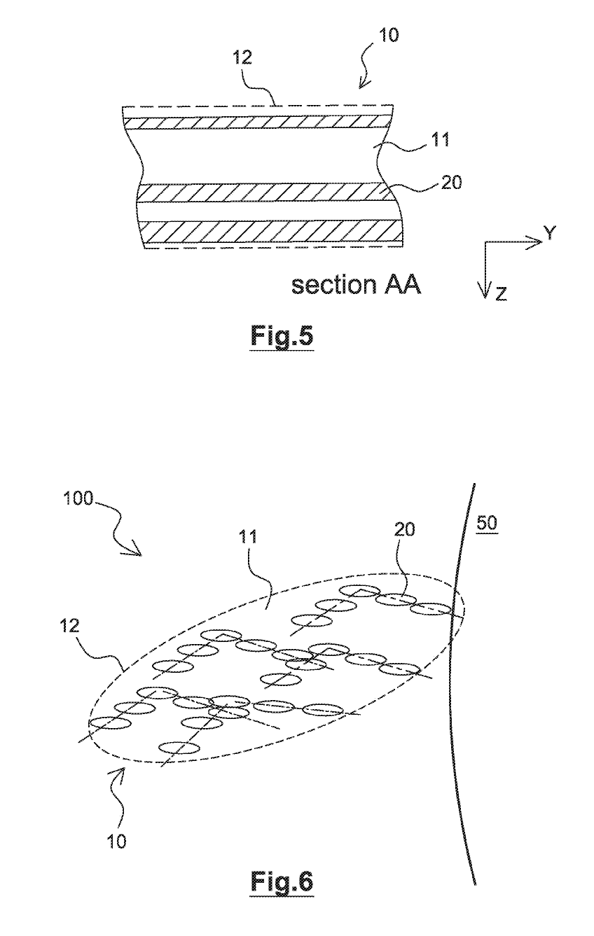

Because the different airfoils 20 are distributed separated from each other in the enclosing volume 11, the result is that, in a vertical section of the wing 10 perpendicular to the longitudinal axis X of the aircraft and for a position along X, an absolute thickness of the enclosing volume 11 represented by the surface 12 of the enclosing volume, is always greater, irrespective of the position in span along the lateral direction Y and the longitudinal position along X, than the sum of the absolute thicknesses of the airfoils 20 intersected by the vertical section. This property of the wing 10, indicated diagrammatically on FIG. 4 and on section AA of FIG. 5, results in a transparency of the wing 10 to the aerodynamic flow which, for a total surface area producing equivalent aerodynamic lift, has the effect of reducing the aerodynamic drag D relative to a conventional wing, in particular the form drag Df.

Each airfoil 20 corresponds to an elementary structure which determines the shape of the airfoil.

In the example illustrated on FIG. 3, each airfoil 20 has a trapezoid shape in plan, in this case reduced to the desired dimensions of the airfoil. The airfoils 20 are also characterized by the shape of their cross-sections in a vertical plane XZ parallel to the longitudinal axis X of the aircraft, which is that of an aerodynamic profile for an airfoil, for example a profile from the numerous NACA family or other profiles of more recent design.

Other shapes in plan are naturally possible for the airfoils, with as much freedom of design as the shapes of a conventional wing: rectangular, simple trapezoid or multi-trapezoid, elliptical, straight, or swept to the rear or reversed, etc.

The elliptical shape in particular is known to correspond in theory to an optimum distribution of circulation of lift on the airfoil concerned, which minimizes the aerodynamic drag Di induced by lift.

In one embodiment (not shown), the various airfoils 20 of a wing 10 do not all have the same span, i.e., a same length in the lateral direction Y of the aircraft axis system. The effect of such a configuration is to give to the enclosing volume 11 a non-rectangular shape viewed from above, for example a trapezoid or elliptical shape.

Not all airfoils necessarily have the same sweep angle, nor necessarily the same shape in plan, both of which could be adapted to a distribution of lift between the different airfoils and on each of the airfoils.

In one embodiment (not shown), all or some of the airfoils are connected together by supporting or reinforcing connecting structures, which may be fixed to a free end of each of the airfoils 20 concerned, or in intermediate span positions between the root and the free end of an airfoil. Such connecting structures allow where applicable the provision of an improved structural rigidity to the wing assembly of the airfoils concerned, and dispel phenomena of instability of the wing structure when the airfoils are subjected to aerodynamic forces.

In one embodiment, the airfoils 20, or at least some thereof, are fixed to the fuselage so as to be able to pivot in a controlled fashion around an axis parallel or substantially parallel to a direction following the span of the airfoil concerned, or the lateral direction Y, such that a pitch angle aα of attack of the airfoil relative to the longitudinal direction X of the aircraft may be modified in flight.

An amplitude of such a pitch is a priori limited to variations of the aerodynamic angle of attack on each airfoil, which in ordinary flight of the aircraft should not lead to aerodynamic detachment from the airfoil concerned. With conventional aerodynamic profiles, the stall angles are of the order of +/−15°, but in the case of the wing 10, the aerodynamic interactions between the different airfoils 20 must be taken into account, which could lead to pitch angles possibly achieving angular values of more than 30° without causing the phenomenon of detachment, because local aerodynamic angles of attack on the airfoil 20 concerned are much smaller than the angle of attack of the wing relative to the direction of flow infinitely upstream.

In this embodiment, in relation to the aerodynamic behavior of the wing 10, it is possible to form a virtual camber of the profile of the enclosing volume 11.

The camber is here considered virtual insofar as the form of the profile corresponding to the enclosing volume is not substantially modified, but the flow is itself modified as if the profile effectively had a modified camber.

For example, a positive virtual camber of the wing results from a modified configuration of the pitch angles of the airfoils, in which the airfoils in a leading edge zone of the wing 10 are oriented with a pitch-up angle aα with a positive angle around the direction of the lateral axis Y, and in which the airfoils in a trailing edge zone of the wing 10 are oriented with a pitch-down angle aα, the angular orientations of the intermediate airfoils between the leading edge zone and the trailing edge zone not being modified or being only slightly modified relative to a cruising flight configuration. In this example of positive camber, an effect is obtained which is comparable to that of a conventional wing provided with high-lift devices on the leading edge and trailing edge, adapted to conditions of reduced speed flight such as during take-off and landing phases.

The use of airfoils 20 which pivot individually or collectively allows different effects to be obtained in relation to the total lift of the wing, the drag of the wing, and by dissymmetry of pivoting of the airfoils distributed on each side of the fuselage 50, the roll or yaw moments applied by the wing 10 to the aircraft 100.

Thus, by pivoting certain airfoils 20 for pitch-down or pitch-up, it is possible to increase or reduce the lift either to achieve control by direct control of the lift, or to increase the lift on take-off, or to reduce the lift on the ground during landing or during an interrupted take-off.

A different modification of lift between the two sides of the aircraft also allows production of a roll moment around the longitudinal axis X.

It is also possible, by differential pivoting of the airfoils situated on the same side of the fuselage, to modify the drag of the wing with a constant total lift, either to achieve a function of aerodynamic braking by a symmetrical application of differential pivoting on both sides of the fuselage, or to generate yaw forces by generating a moment around the vertical axis Z by different application of differential pivoting between the two sides of the fuselage.

Differential pivoting of the airfoils, between the airfoils situated close to the leading edge of the wing 10 and airfoils situated close to the trailing edge of the wing, also allows modification of the pitch-up or pitch-down moment generated by the wing 10 around the transverse axis Y.

These different examples show that the wing 10, by individual control in flight of the pitch angle of all or some of the airfoils, allows action on the lift and drag forces and on the moments around the different axes X, Y and Z, which is advantageously exploited to control the trajectory and attitude of the aircraft in flight by controlling the pitch angle of the airfoils via a system of flight controls.

In one embodiment, the aircraft has no horizontal tailplane and/or no vertical tailplane, or reduced tailplane surfaces, wherein the functions of balancing, stabilization and attitude control around the axis concerned are fulfilled at least partially by the in-flight control of the pitch angle of the airfoils.

The possibility of pivoting an airfoil 20 is obtained, for example, by a rotation shaft via which the airfoil is attached to the fuselage.

An airfoil corresponds to a juxtaposition of aerodynamic profiles, a thickness of which is selected following conventional aerodynamic criteria, in particular a cruising flight Mach number, and following structural criteria.

The choice of profile of the airfoil arises from the same criteria as that of a profile of a conventional aircraft wing.

In an alternative embodiment illustrated on FIG. 6, the airfoils 20, drawn elliptical on FIG. 6, have span dimensions which are smaller than the span of the wing, and the airfoils are distributed in the enclosing volume 11 of the wing 10 without necessarily being in direct contact with the fuselage.

The airfoils 20 which are not in direct contact with the fuselage are necessarily attached to the fuselage or to each other either by a specific supporting structure or by a structure which incorporates the different airfoils, for the transmission of forces between each airfoil and the fuselage 50. These structures are not shown on FIG. 6.

The airfoils 20 are thus distributed in the enclosing volume 11 of the wing 10 as in the embodiment described above, adding a distribution in the lateral direction Y in the span of the wing 10.

In this embodiment, the airfoils 20 are advantageously distributed in the enclosing volume 11 to take advantage of the aerodynamic interactions between the different airfoils.

In the example of distribution of the airfoils 20 illustrated on FIG. 6, the airfoils are distributed to form V-shaped formations in a view from above, the tip of the V being oriented towards the leading edge of the wing 10.

This type of V-shaped distribution is in particular used by migrating birds during their long migration flights.

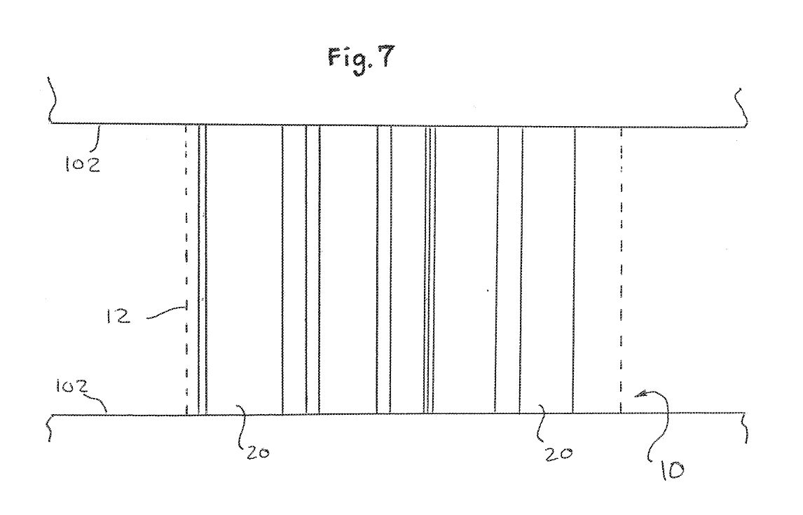

In one embodiment, the fuselage of the aircraft 100, described above with a single streamlined body, comprises two or more streamlined bodies 102 extending in the direction of the longitudinal axis X (FIG. 7), the streamlined bodies being advantageously held together by airfoils 20 of the wing 10 according to the invention.

The embodiment of an aircraft 100 according to the invention, comprising a wing 10 formed by a plurality of airfoils 20, allows an improvement in the aerodynamic performance of lift and/or drag relative to aircraft comprising a conventional wing.

These performance improvements result from the possibility of producing wings with enclosing volumes, the shapes of which would raise difficulties in production in the case of conventional wings, for example with reversed sweep.

The result is a lighter weight of the wing and fuselage structures because of the reduction in absolute forces on the airfoils, which weight reduction leads to a reduction in the surface areas necessary to ensure lift during flight, the possible elimination of tailplane surfaces, the functions of which may be achieved by actions on the movably mounted airfoils, reduced root moments on the fuselage, and finer profiles which could not be achieved on larger wings.

The aircraft 100 with movable airfoils also benefits from increased capacity for aerodynamic control of speed via the drag, direct control of lift and high-lift functions without the need to implement a specific device other than the airfoils 20 of the wing 10, which are therefore each much simpler than a wing provided with numerous movable surfaces such as conventional wings.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-10. (canceled)

11. An aircraft comprising:
a fuselage, and
at least one wing,
the wing, on an aerodynamic plane, comprising a plurality of distributed airfoils separated from one another, numbering ten or more, and arranged inside an enclosing volume bearing on said airfoils,
a shape and dimensions of said enclosing volume corresponding to a shape and dimensions of a single wing of conventional structure which is adapted to the aircraft taking account of a mass and flying speed of said aircraft, and
cross-sections of said enclosing volume, in a vertical plane, having a shape of an aerodynamic profile of said single wing of conventional structure.

12. The aircraft as claimed in claim 11, wherein the enclosing volume has a shape in plan, viewed from above, belonging to one of the shapes: rectangular, trapezoid, multi-trapezoid, elliptical.

13. The aircraft as claimed in claim 11, wherein the enclosing volume has a shape in plan, viewed from above, presenting a sweep.

14. The aircraft as claimed in claim 11, wherein a height of the enclosing volume considered in a vertical direction, is always greater, at any lateral or longitudinal point of said enclosing volume, than a sum of heights of the airfoils for each of the lateral or longitudinal points considered, other than points of a leading edge or a trailing edge of said enclosing volume.

15. The aircraft as claimed in claim 11, wherein at least some of the airfoils are fixed to the fuselage via a root of each of said airfoils concerned.

16. The aircraft as claimed in claim 11, wherein the wing comprises several separate airfoils distributed along a span of the enclosing volume.

17. The aircraft as claimed in claim 16, wherein the airfoils are arranged in the enclosing volume along a span of the wing, such that they comprise at least one composite V-shape when viewed from above, a tip of the V-shape being oriented towards a leading edge of the wing.

18. The aircraft as claimed in claim 11, wherein at least some of the airfoils are assembled to pivot individually or in groups about an axis oriented following a direction of a transverse axis of the aircraft, so as to allow modification in flight of a pitch angle of the airfoil concerned relative to a longitudinal axis of the aircraft.

19. The aircraft as claimed in claim 11, wherein at least some of the airfoils are assembled to pivot individually or in groups about an axis oriented following a direction substantially parallel to a direction of a span of the wing, so as to allow modification in flight of a pitch angle of the airfoil concerned relative to a longitudinal axis of the aircraft.

20. The aircraft as claimed in claim 11, wherein at least some of the airfoils are assembled to pivot individually or in groups about an axis oriented following a span of the airfoil concerned, so as to allow modification in flight of a pitch angle of the airfoil concerned relative to a longitudinal axis of the aircraft.

21. The aircraft as claimed in claim 11, wherein at least some of the airfoils are assembled to pivot individually or in groups about an axis oriented following a direction substantially parallel to a vertical axis of the aircraft, so as to allow modification in flight of a sweep angle of the airfoil concerned relative to a lateral direction of the aircraft.

22. The aircraft as claimed in claim 11, wherein the fuselage comprises several streamlined forms held together by the airfoils of the wing.

23. An aircraft comprising:
a fuselage, and
at least one wing,
the wing comprising at least ten distributed airfoils separated from one another and arranged inside an enclosing volume bearing on said airfoils,
a shape and dimensions of said enclosing volume corresponding to a shape and dimensions of a single wing having an aerodynamic profile and producing an equivalent aerodynamic lift as a combined lift produced by said distributed airfoils.
